(19) United States
(12) Patent Application Publication
(10) Pub. No.: US 2025/0297732 A1
(43) Pub. Date: Sep. 25, 2025

(54) TWIST-LOCK LIGHT CONTROL MODULE FOR A LIGHT FIXTURE

(71) Applicant: TE Connectivity Solutions GmbH, Schaffhausen (CH)

(72) Inventors: Matthew Edward Mostoller, Hummelstown, PA (US); Christopher George Daily, Harrisburg, PA (US)

(21) Appl. No.: 19/023,691

(22) Filed: Jan. 16, 2025

Related U.S. Application Data
(60) Provisional application No. 63/568,640, filed on Mar. 22, 2024.

(51) Int. Cl. F21V 23/06; F21V 17/14; F21V 23/00; F21V 23/04; F21W 131/103

(52) U.S. Cl. CPC F21V 23/06; F21V 17/14; F21V 23/001; F21V 23/006; F21V 23/008; F21V 23/0442; F21W 2131/103

(57) ABSTRACT

A light control module includes a plug connector configured to be mated with a receptacle connector mounted to the light fixture. The plug connector has a plug connector housing holding plug power contacts. The plug connector housing has a base with a top configured to support a control circuit board and a bottom facing the receptacle connector. The plug power contacts are received in power contact channels and include twist lock plug terminals and board terminals. The twist lock plug terminals have mating ends have rotate-to-mate interfaces configured to be connected to the receptacle power contacts in a rotation direction. The board terminals have mating ends configured to be electrically connected to the control circuit board to electrically connect the twist lock plug terminals to the control circuit board.

### CROSS REFERENCE TO RELATED APPLICATIONS

This application claims benefit to U.S. Provisional Application No. 63/568,640, filed 22 Mar. 2024, the subject matter of which is herein incorporated by reference in its entirety.

### BACKGROUND OF THE INVENTION

The subject matter herein relates generally to connectors for light fixtures.

On outdoor lighting, notably street lights and parking lot lights, sensor components and the corresponding mating receptacles are typically used to turn the lights on and off based upon the ambient light from the sun. The sensor components and the mating receptacles are mated at a rotate-to-mate interface using twist-lock power contacts. Some light fixtures support dimming to variably control the light fixture based on the ambient light levels, time of day, and the like. The light fixture includes a receptacle connector and a plug connector mated together at a rotate-to-mate interface for the sensor module. The power contacts of the electrical connectors are arranged in a central portion of the connectors. The power contacts of the plug connector extend through the housing of the plug connector to terminate directly to a printed circuit board of the sensor module. However, the printed circuit board typically has various components terminated to the printed circuit board and space in the central portion fo the printed circuit board may be limited for terminating the power contacts to the printed circuit board.

A need remains for a reliable method of terminating the power contacts to the printed circuit board of the sensor module.

### BRIEF DESCRIPTION OF THE INVENTION

In one embodiment, a light control module for a light fixture is provided and includes a plug connector configured to be mated with a receptacle connector mounted to the light fixture. The plug connector has a plug connector housing holding plug power contacts configured to electrically connect to receptacle power contacts of the receptacle connector for power control of the light fixture. The plug connector housing has a base with a top and a bottom. The bottom is configured to face the receptacle connector. The top is configured to support a control circuit board. The base has power contact channels. The plug power contacts received in the corresponding power contact channels. The plug power contacts including twist lock plug terminals and board terminals electrically connected to and extending from the twist lock plug terminals. The twist lock plug terminals have mating ends have rotate-to-mate interfaces configured to be connected to the receptacle power contacts in a rotation direction. The board terminals have mating ends configured to be electrically connected to the control circuit board to electrically connect the twist lock plug terminals to the control circuit board.

In another embodiment, a light control module for a light fixture is provided and includes a plug connector configured to be mated with a receptacle connector mounted to the light fixture. The plug connector has a plug connector housing holding plug power contacts configured to electrically connect to receptacle power contacts of the receptacle connector for power control of the light fixture. The plug connector housing has a base with a top and a bottom. The bottom is configured to face the receptacle connector. The base has power contact channels. The plug power contacts received in the corresponding power contact channels. The plug power contacts including twist lock plug terminals and board terminals electrically connected to and extending from the twist lock plug terminals. The twist lock plug terminals have mating ends have rotate-to-mate interfaces configured to be connected to the receptacle power contacts in a rotation direction. The board terminals have mating ends. The light control module includes a sensor module coupled to the plug connector. The sensor module has a sensor module housing, a control circuit board held by the sensor module housing, and a sensor element coupled to the control circuit board. The sensor element held by the sensor module housing for sensing an environmental characteristic exterior of the sensor module. The control circuit board being mounted to the top of the base of the plug connector, wherein the mating ends of the board terminals are terminated to the control circuit board.

In a further embodiment, a light control module for a light fixture is provided and includes a receptacle connector configured to be mounted to the light fixture. The receptacle connector includes a receptacle connector housing holding receptacle power contacts configured to be electrically connected to power wires of the light fixture. The receptacle connector housing includes a mating interface at a top of the receptacle connector housing. The receptacle connector housing includes power contact channels holding the corresponding receptacle power contacts. The receptacle power contacts including twist lock receptacle terminals have sockets at mating ends having rotate-to-mate interfaces. The light control module includes a plug connector mated with a receptacle connector at the mating interface. The plug connector has a plug connector housing holding plug power contacts electrically connected to corresponding receptacle power contacts of the receptacle connector for power control of the light fixture. The plug connector housing has a base with a top and a bottom. The bottom facing the top of the receptacle connector. The base has power contact channels. The plug power contacts received in the corresponding power contact channels. The plug power contacts including twist lock plug terminals and board terminals electrically connected to and extending from the twist lock plug terminals. The twist lock plug terminals have mating ends have rotate-to-mate interfaces configured to be connected to the corresponding rotate-to-mate interfaces of the twist lock receptacle terminals in a rotation direction. The board terminals have mating ends. The light control module includes a sensor module coupled to the plug connector. The sensor module has a sensor module housing, a control circuit board held by the sensor module housing, and a sensor element coupled to the control circuit board. The sensor element held by the sensor module housing for sensing an environmental characteristic exterior of the sensor module. The control circuit board being mounted to the top of the base of the plug connector, wherein the mating ends of the board terminals are terminated to the control circuit board.

### BRIEF DESCRIPTION OF THE DRAWINGS

FIG. 1 illustrates a light control module formed in accordance with an exemplary embodiment.

FIG. 2 is an exploded perspective view of the light control module in accordance with an exemplary embodiment showing the plug connector and the sensor module poised for mating with the receptacle connector.

FIG. 3 is a perspective view of a portion of the light control module showing the plug connector and the control circuit board coupled to the plug connector in accordance with an exemplary embodiment.

FIG. 4 is a top view of a portion of the light control module showing the control circuit board coupled to the plug connector in accordance with an exemplary embodiment.

FIG. 5 is a bottom perspective view of the plug connector in accordance with an exemplary embodiment.

FIG. 6 is a top perspective view of the plug connector in accordance with an exemplary embodiment.

FIG. 7 is a top perspective view of the plug connector in accordance with an exemplary embodiment.

FIG. 8 is a perspective view of one of the board terminals from the embodiment shown in FIG. 7 in accordance with an exemplary embodiment.

FIG. 9 is a top perspective view of a portion of the plug connector shown in FIG. 7 in accordance with an exemplary embodiment.

FIG. 10 is a top perspective view of a portion of the plug connector showing the board terminal poised for loading into the base in accordance with an exemplary embodiment.

FIG. 11 is a top perspective view of a portion of the plug connector showing the terminating end of the board terminal in accordance with an exemplary embodiment.

FIG. 12 is a top perspective view of a portion of the plug connector showing the mating end of the board terminal in accordance with an exemplary embodiment.

### DETAILED DESCRIPTION OF THE INVENTION

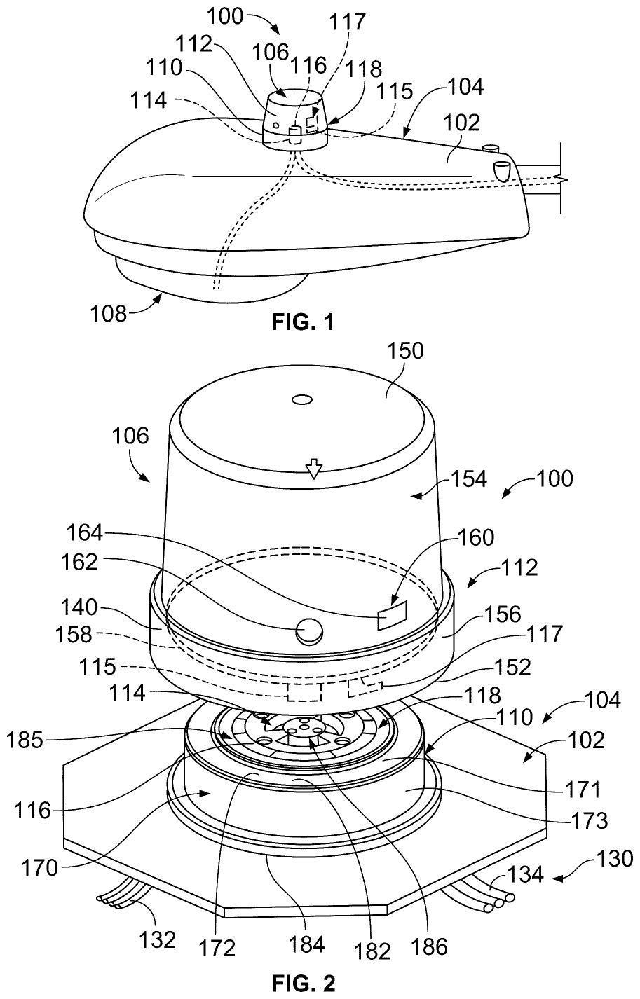

FIG. 1 illustrates a light control module 100 formed in accordance with an exemplary embodiment. The light control module 100 is mounted to a fixture housing 102 of a light fixture 104, such as a roadway light, a parking lot light, a street light, and the like, or to another component, such as the pole or other structure supporting the light fixture 104, or to another component unassociated with the light fixture, such as a parking meter, a telephone pole or another structure. The light control module 100 holds a sensor module 106 that may be used for environmental monitoring or to control the light fixture 104, such as for turning a lighting element 108 of the light fixture 104 on or off depending upon light levels, for dimming control of the lighting element 108, or for controlling other functions. The lighting element 108 may be an LED lighting element in various embodiments.

The sensor module 106 may be used for other functions other than controlling the light fixture 104, such as remote monitoring of the environmental surroundings of the fixture housing 102, such as for parking monitoring, for street flow activity monitoring, or other functions. The sensor module 106 may be a photocell or light sensor used to detect ambient light from the sun. Other types of sensor components, such as object identification sensors, motion sensors, timing sensors or other types of environmental sensors may be included in the light control module 100.

The light control module 100 includes a receptacle connector 110 and a plug connector 112 coupled to the receptacle connector 110. The sensor module 106 is mounted to or part of the plug connector 112. The plug connector electrically connects the sensor module 106 to the receptacle connector 110. In an exemplary embodiment, the connectors 110, 112 are twist-lock connectors and may be referred to hereinafter as twist-lock connectors 110, 112. The twist-lock connectors 110, 112 are mated at a rotate-to-mate interface. For example, the twist-lock connectors 110, 112 are initially mated in a plug mating direction along a mating axis and are finally mated in a rotate mating direction by rotating the twist lock connector 112 and/or the twist-lock connector 110 to lock the connectors 110, 112 together. In an exemplary embodiment, the receptacle connector 110 is a twist-lock photocontrol receptacle connector and the plug connector 112 is a twist-lock photocontrol plug connector, such as connectors being ANSI C136.x compliant.

The receptacle connector 110 forms the bottom of the light control module 100. The receptacle connector 110 may be directly mounted to the fixture housing 102 of the light fixture 104. The sensor module 106 forms the top of the light control module 100. For example, the sensor module 106 houses or surrounds a sensor component, such as to provide environmental protection for the sensor component.

In an exemplary embodiment, power and data may be transmitted between the plug connector 112 and the receptacle connector 110 across a mating interface 118. The connectors 110, 112 include power contacts 114, 116 (shown in phantom in FIG. 2) and signal contacts 115, 117 at the mating interface 118. The power contacts 114, 116 may be twist-lock power contacts. The power contacts 114, 116 may be high voltage power contacts. The signal contacts 115, 117 may be low speed data contacts for transmitting low speed data signals across the mating interface 118. For example, control signals may be transmitted by the low speed signal contacts 115, 117 from the plug connector 112 to the receptacle connector 110 for controlling operation of the light fixture 104. The control signals may be based on sensor data gathered by the sensor module 106.

FIG. 2 is an exploded perspective view of the light control module 100 in accordance with an exemplary embodiment showing the plug connector 112 and the sensor module 106 poised for mating with the receptacle connector 110. The connectors 110, 112 hold the power contacts 114, 116 and the signal contacts 115, 117. Optionally, a seal (not shown) may be provided between the receptacle connector 110 and the plug connector 112 to seal the light control module 100 at the mating interface 118 from environmental containments such as water, debris, and the like.

In an exemplary embodiment, the light control module 100 includes a wire harness 130 coupled to the receptacle connector 110. The wire harness 130 includes signal wires 132 and power wires 134. The signal wires 132 are configured to be coupled with corresponding signal contacts 115, such as after the receptacle connector 110 is mounted to the fixture housing 102. The signal wires 132 may transmit data to or from the receptacle connector 110 for data communication with the plug connector 112. For example, control signals for controlling operation of the light fixture 104, such as ON/OFF or dimming signals, may be transmitted from the plug connector 112 to the receptacle connector 110. The signal wires 132 may be connected to a light driver for the light fixture 104. In other embodiments, the signal wires 132 may be electrically connected to another component, such as a video camera, to transmit video signals.

In an exemplary embodiment, the power wires 134 are terminated to corresponding power contacts 114, such as after the receptacle connector 110 is mounted to the fixture housing 102. The wire harness 130 may be installed in the field, such as when installed in the light fixture 104. The power wires 134 may be power in or power out wires bringing power to the light control module 100 from a power source or bringing power from the power contacts 114 to another component, such as the lighting element 108 or a driver board for the lighting element of the light fixture 104. In various embodiments, the power wires 134 may include a line wire, a load wire, a neutral wire or other types of wires.

The receptacle connector 110 includes a receptacle connector housing 170 having a base 172 extending between a top 182 and a bottom 184. The connector housing 170 includes an end wall 171 at the top 182 and a side wall 173 extending between the top 182 and the bottom 184. The end wall 171 defines the mating interface with the plug connector 112. The bottom 184 of the base 172 is configured to be secured to the fixture housing 102.

The connector housing 170 holds the power contacts 114 and signal contacts 115. The signal contacts 115 are received in signal contact channels 185 and extend to the top 182 for interfacing with the plug connector 112. The power contacts 114 are held in power contact channels 186 within the base 172. Optionally, the power contacts 114 may be entirely contained within the base 172 and protected from the environment by the base 172. Optionally, the power contact channels 186 include arcuate or curved slots or openings in the base 172 for twist-lock mating with the sensor contacts.

In an exemplary embodiment, the receptacle connector 110 is generally cylindrical shaped, such as to allow easy rotation of the plug connector 112 relative to the receptacle connector 110 and/or to allow easy rotation of the receptacle connector 110 relative to the fixture housing 102. However, the receptacle connector 110 may have other shapes and alternative embodiments. In an exemplary embodiment, the plug connector 112 may be rotatable relative to the receptacle connector 110, such as to allow rotating mating of the plug connector 112 with the receptacle connector 110.

The sensor module 106 includes a sensor module housing 140 extending between a top 150 and a bottom 152. The sensor module housing 140 has a mating interface at the bottom 152 configured to be secured to the plug connector 112 and/or the receptacle connector 110. In an exemplary embodiment, the sensor module 106 includes a sensor lid 154 at the top 150 of the housing 140 and a base 156 at the bottom 152. The sensor lid 154 may include a dome configured to circumferentially surrounding the base 156 of the sensor module 106. Sensor components 160 are arranged in the sensor lid 154. In an exemplary embodiment, the sensor module 106 is cylindrical shaped, such as to allow easy rotation of the sensor module 106 relative to the receptacle connector 110, such as during mating. However, the sensor module 106 may have other shapes and alternative embodiments.

In an exemplary embodiment, the sensor module 106 includes a control circuit board 158 (shown in phantom) arranged in the base 156 and/or the sensor lid 154. The sensor component(s) 160 may be coupled to the control circuit board 158, such as being mounted to the control circuit board 158. Other components may be mounted to the control circuit board 158. For example, a control module and/or communication device may be mounted to the circuit board 158.

In an exemplary embodiment, the sensor module 106 includes different types of environmental sensor components 160 for sensing different events. For example, the sensor module 106 includes a photocell 162. The photocell 162 is used for sensing ambient light and is used to control operation of the light fixture 104, such as for turning the light fixture 104 on or off depending upon light levels or for dimming control of the light fixture 104. Optionally, the photocell 162 may be mounted to the circuit board 158 and/or the sensor lid 154. The sensor signal contacts 117 and the photocell 162 may be electrically connected via the circuit board 158. The circuit board 158 may include additional componentry for signal conditioning. For example, the circuit board 158 may have control circuitry for controlling operation of the light fixture 104, such as including a daylight or nighttime control circuit, a timer circuit, a dimming circuit, and the like. Data from the photocell 162 may be transmitted through the signal contacts across the mating interface 118.

In an exemplary embodiment, the sensor module 106 includes one or more other environmental sensors 164 for sensing an environmental characteristic other than ambient light exterior of the light control module 100 in the environment exterior of the sensor module 106. For example, the sensor 164 may be a motion sensor or an object sensor configured to sense movement or presence of an object, such as a person or vehicle in a particular area. The sensor 164 may be used for parking monitoring, for street flow activity monitoring, for pedestrian monitoring, or other functions. The sensor 164 may be mounted to the circuit board 158. In an exemplary embodiment, the sensor 164 is electrically connected to the sensor signal contacts 117 via the control circuit board 158.

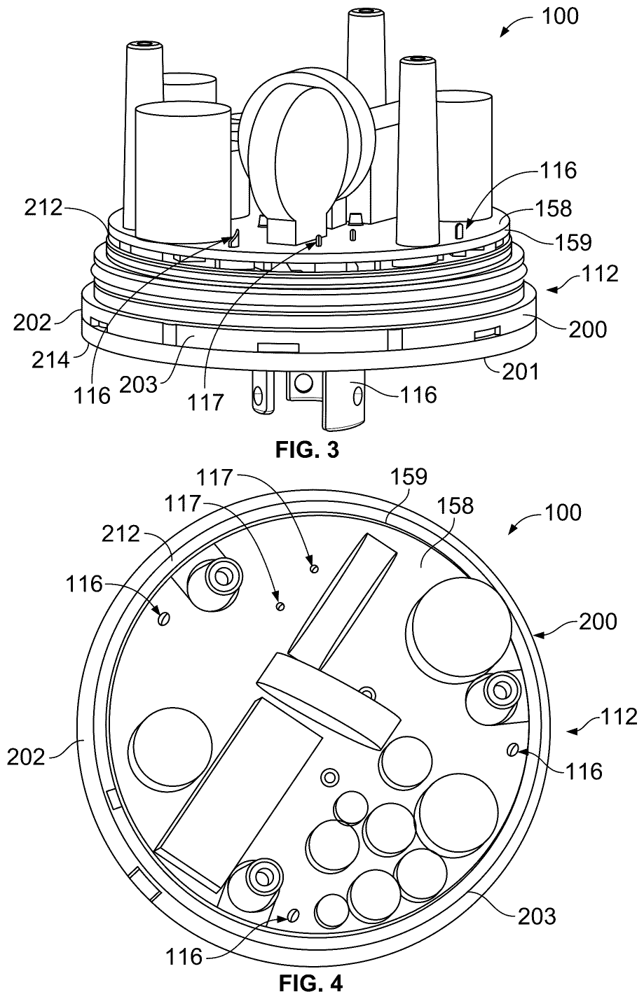

FIG. 3 is a perspective view of a portion of the light control module 100 showing the plug connector 112 and the control circuit board 158 coupled to the plug connector 112. FIG. 4 is a top view of a portion of the light control module 100 showing the control circuit board 158 coupled to the plug connector 112. Sensor lid 154 (shown in FIG. 2) has been removed to illustrate the control circuit board 158 mounted to the plug connector 112. In the illustrated embodiment, the control circuit board 158 is circular having a circular outer edge 159. However, the control circuit board 158 may have other shapes in alternative embodiments. Various components are mounted to the top surface of the control circuit board 158, such as the environmental sensor components 160 and control circuit components.

The plug connector 112 includes a plug connector housing 200 having a base 202 extending between a top 212 and a bottom 214. The control circuit board 158 is mounted to the plug connector 112 at the top 212. The connector housing 200 includes an end wall 201 at the bottom 214 and a side wall 203 extending between the top 212 and the bottom 214. The end wall 201 defines the mating interface with the receptacle connector 110. The bottom 214 of the base 202 is configured to be secured to the receptacle connector 110. The sensor lid 154 may be coupled to the end wall 201 and/or the side wall 203.

The connector housing 200 holds the power contacts 116 and signal contacts 117. For example, the connector housing 200 holds the power contacts 116 and the signal contacts 117 for mating with the control circuit board 158 and for mating with the receptacle connector 110. In an exemplary embodiment, the power contacts 116 and the signal contacts 117 are connected to the control circuit board 158 at locations that do not interfere or interrupt with positioning of the components on the control circuit board 158. For example, the power contacts 116 and/or the signal contacts 117 may be terminated to the control circuit board 158 proximate to the outer edge 159 rather than in the central region where the components are mounted. In an exemplary embodiment, the power contacts 116 extend downward from the bottom 214 for mating with the receptacle power contacts 114 of the receptacle connector 110.

In an exemplary embodiment, the plug connector 112 is generally cylindrical shaped, such as to allow easy rotation of the plug connector 112 relative to the receptacle connector 110. However, the plug connector 112 may have other shapes and alternative embodiments. In an exemplary embodiment, the plug connector 112 may be rotatable relative to the receptacle connector 110, such as to allow rotating mating of the plug connector 112 with the receptacle connector 110.

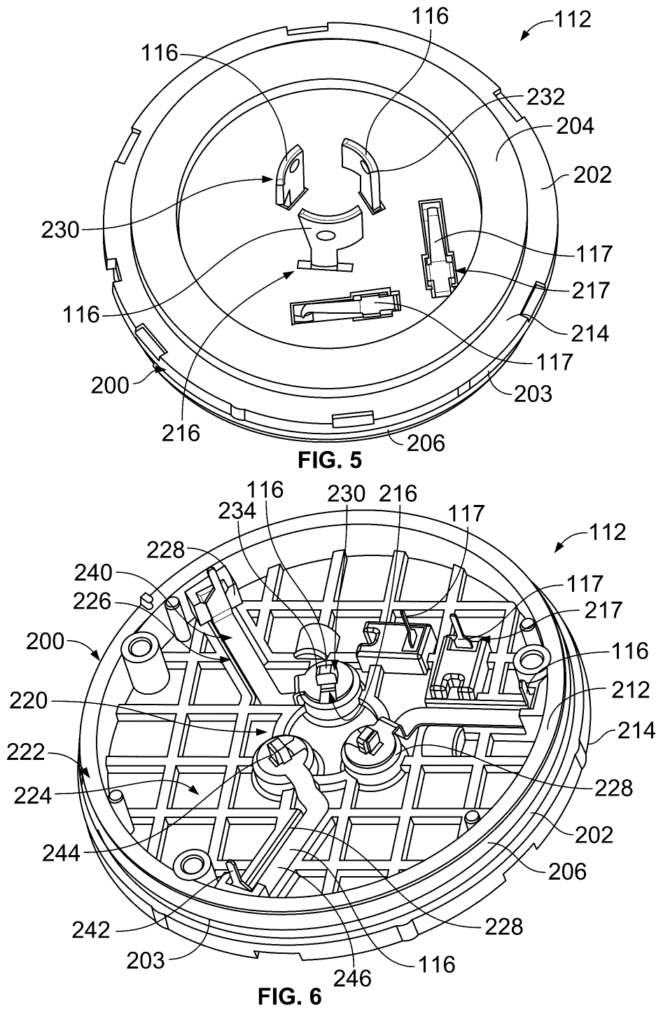

FIG. 5 is a bottom perspective view of the plug connector 112 in accordance with an exemplary embodiment. FIG. 6 is a top perspective view of the plug connector 112 in accordance with an exemplary embodiment. The plug connector 112 includes the plug connector housing 200, which holds the plug power contacts 116 and the plug signal contacts 117. For example, the plug power contacts 116 and the plug signal contacts 117 may be held by the base 202. In an exemplary embodiment, the plug connector 112 includes a seal or gasket 204 at the bottom 214 of the base 202, which may be connected to the receptacle connector 110 (shown in FIG. 2). The plug connector 112 may include a seal or gasket 206 around the outer perimeter of the base 202 configured to seal to the sensor lid 154 of the sensor module 106 (shown in FIG. 2).

In an exemplary embodiment, the base 202 includes an inner hub 220, an outer rim 222, and a platform 224 between the inner hub 220 and the outer rim 222. The inner hub 220 is located in the central region of the base 202, such as aligned with the central axis. The outer rim 222 is located at the side wall 203 and is spaced radially outward of the inner hub 220. In an exemplary embodiment, the plug power contacts 116 are arranged at the inner hub 220 for connection to the receptacle connector 110 and are arranged proximate to the outer rim 222 for connection to the control circuit board 158. For example, portions of the plug power contacts 116 extend radially outward, such as along the platform 224, between the inner hub 220 and the outer rim 222 for convenient termination to the control circuit board 158, such as to avoid the various components mounted to the control circuit board 158.

The plug signal contacts 117 are received in signal contact channels 217 in the plug connector housing 200 and arranged at the top 212 and the bottom 214 for interfacing with the control circuit board 158 and the receptacle connector 110. The plug power contacts 116 are held in power contact channels 216 in the plug connector housing 200. The power contact channels 216 are located at the inner hub 220 and pass between the top 212 and the bottom 214 of the plug connector housing 200.

The plug signal contacts 117 (shown in phantom) may be held by the plug connector housing 200, such as being held by the base 202. The plug signal contacts 117 extend from the top 212 for termination to the circuit board 158. For example, the plug signal contacts 117 may include tails or pins at the top configured to be plugged into plated vias of the circuit board 158. The tails may be soldered to the corresponding circuits of the circuit board 158. The plug signal contacts 117 may extend from the bottom 214 for mating with the signal contacts 115 of the receptacle connector 110. Optionally, the plug signal contacts 117 may be spring beam contacts having spring beams at mating ends of the plug signal contacts 117 forming a separable mating interface with the receptacle signal contacts 115. The plug signal contacts 117 may be other types of contacts in alternative embodiments.

The plug power contacts 116 are held by the plug connector housing 200, such as being held by the base 202. The plug power contacts 116 are received in the power contact channels 216 to pass through the base 202 between the bottom 214 and the top 212. In an exemplary embodiment, the base 202 includes troughs 226 at the top 212 that receive portions of the plug power contacts 116. The troughs 226 are formed in the platform 224 and provide a space that receives and supports the plug power contacts 116. The troughs 226 extend radially outward from the inner hub 220 to the outer rim 222. The plug power contacts 116 extend between the inner hub 220 and the outer rim 222 in the troughs 226. The plug power contacts 116 extend from the top 212 for termination to the circuit board 158. The plug power contacts 116 extend from the bottom 214 for mating with the receptacle power contacts 114.

The plug power contacts 116 may be arranged generally around a central axis. Optionally, the plug power contacts 116 may be twist lock contacts. For example, the plug power contacts 116 may be curved and fit in the curved contact channels 186 in the receptacle connector 110 to mate with corresponding curved power contacts 114. In an exemplary embodiment, the plug connector 112 may be twisted or rotated to lock the plug power contacts 116 in the receptacle connector 110, such as in electrical contact with the power contacts 114. For example, the plug power contacts 116 may be twist-lock contacts that are initially loaded into the contact channels 186 of the receptacle connector 110 in a vertical direction and the plug connector 112 is then rotated, such as approximately 35 degrees, to lock the plug power contacts 116 in the receptacle connector 110. Other types of mating arrangements between the plug power contacts 116 and the receptacle power contacts 114 are possible in alternative embodiments.

In an exemplary embodiment, the plug power contacts 116 include twist lock plug terminals 230 and board terminals 240 electrically connected to and extending from the twist lock plug terminals 230. The twist lock plug terminals 230 and the board terminals 240 are separate and discrete from each other. In an exemplary embodiment, the twist lock plug terminals 230 are stamped and formed contacts. In an exemplary embodiment, the board terminals 240 are stamped and formed contacts. The board terminals 240 may be stamped from a different blank or sheet than the twist lock plug terminals 230. For example, the twist lock plug terminals 230 and the board terminals 240 may be stamped from different material. The twist lock plug terminals 230 and the board terminals 240 may be stamped from sheets having different thicknesses. The twist lock plug terminals 230 and the board terminals 240 may have different plating layers.

Each twist lock plug terminal 230 extends between a mating end 232 and a terminating end 234. The mating end 232 is at the bottom 214 and is configured to be mated with the receptacle power contact 114. The terminating end 234 is at the top 212 and is configured to be electrically connected to the corresponding board terminal 240. In an exemplary embodiment, the twist lock plug terminals 230 includes a post at the terminating end 234. The post is configured to be welded or soldered to the board terminal 240. In an exemplary embodiment, the mating end 232 includes a curved blade. The curved blade is curved along an arcuate path. The curved blade is configured to be plugged into the receptacle connector 110 to mate with the corresponding receptacle power contact 114, such as by a twist-lock mating action. For example, the mating end 232 has a rotate-to-mate interface configured to be connected to the receptacle power contact 114 in a rotation direction. In the illustrated embodiment, the twist lock plug terminals 230 are arranged at the inner hub 220. The twist lock plug terminals 230 pass through the power contact channels 216. The twist lock plug terminals 230 are arranged around the central axis, such as spaced equidistant around a circumference of the inner hub 220.

Each board terminal 240 extends between a mating end 242 and a terminating end 244. The board terminal 240 includes an intermediate body 246 between the mating end 242 and the terminating end 244. The intermediate body 246 is received in the corresponding trough 226. In the illustrated embodiment, the intermediate body 246 lays flat in the trough 226. The intermediate body 246 extends radially between the mating end 242 and the terminating end 244. The intermediate body 246 may extend along a linear path between the mating end 242 and the terminating end 244. Alternatively, the intermediate body 246 may extend along a non-linear path, such as including one or more bends to route the board terminal 240 along a designated path. In various embodiments, the board terminals 240 are identical (for example, stamped and formed identically) and extend from the respective twist lock plug terminals 230 in different directions. Optionally, the mating ends 242 may be equidistantly spaced (for example, spaced 120° apart) around the outer perimeter of the base 202. In alternative embodiments, the board terminals 240 may extend in different directions, such as to position the mating ends 242 non-equidistant. For example, all of the mating ends 242 may be arranged in the same area for connection to the control circuit board 158. The board terminals 240 may have different shapes in alternative embodiments, such as having different length and/or different shaped intermediate bodies 246.

The terminating end 244 is configured to be electrically connected to the twist lock plug terminal 230, such as to the terminating end 234 of the twist lock plug terminal 230. For example, the terminating end 244 may be soldered or welded to the terminating end 234. The mating end 242 is configured to be electrically connected to the control circuit board 158 to electrically connect the twist lock plug terminal 230 to the control circuit board 158. In the illustrated embodiment, the mating end 242 includes a pin or a tail configured to be plugged into a plated via in the control circuit board 158. The tail may be soldered to the plated via. In other embodiments, the pin at the mating end 242 may be a compliant pin configured to be press fit in the plated via. The mating end 242 is located radially outward relative to the terminating end 244. For example, the terminating end 244 may be located at the inner hub 220 and the mating end 242 is located proximate to the outer rim 222. The mating end 242 is located proximate to a radially outer end of the plug connector housing 200, such as proximate to the side wall 203.

The base 202 includes locating walls 228 used to locate the board terminal 240 along the top 212 of the base 202. The locating walls 228 may define the troughs 226. The locating walls 228 may hold or locate the mating end 242 and/or the terminating end 244. The board terminals 240 may include securing features (not shown) configured to engage the base 202 to hold the board terminals 240 in the troughs 226. For example, the securing features may be crush ribs, interference bumps, barbs, or other types of securing features.

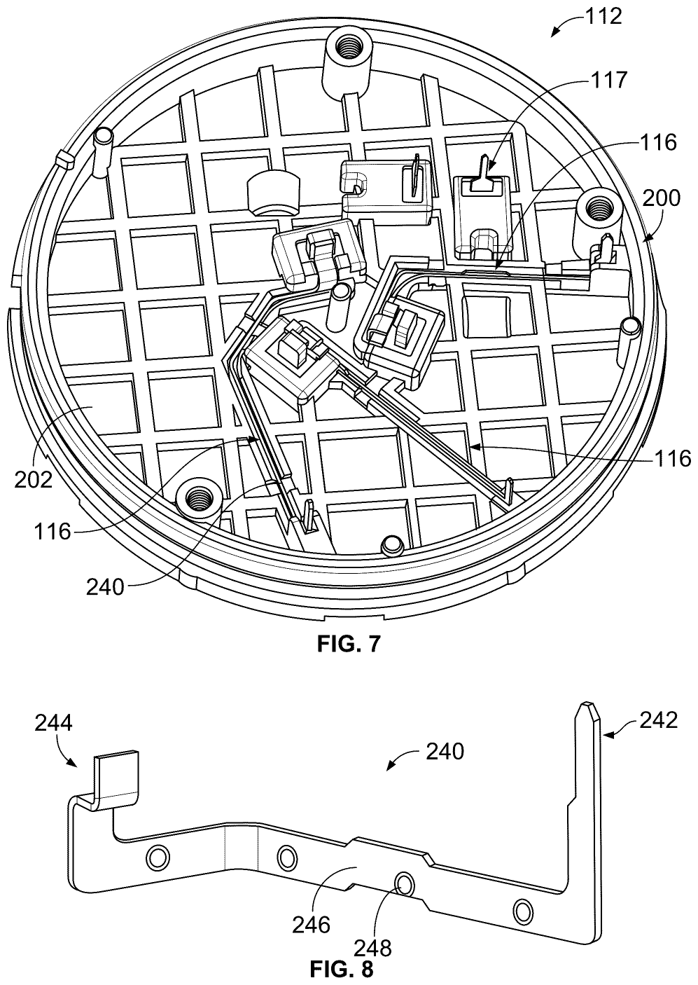

FIG. 7 is a top perspective view of the plug connector 112 in accordance with an exemplary embodiment. The plug connector 112 includes similar elements as the plug connector 112 shown in FIG. 6 and like components are identified using like reference numerals. The plug connector 112 includes the plug connector housing 200, which holds the plug power contacts 116 and the plug signal contacts 117. In the illustrated embodiment, the board terminals 240 of the plug power contacts 116 are stamped and formed differently than the embodiment shown in FIG. 6. For example, the board terminals 240 are oriented stand up generally vertically rather than laying flat generally horizontally. The board terminals 240 are shown extending in different directions than shown in FIG. 6. For example, all three of the board terminals 240 extend to the same quadrant of the base 202 for electrical connection to the control circuit board 158.

FIG. 8 is a perspective view of one of the board terminals 240 from the embodiment shown in FIG. 7. The board terminal 240 is a stamped and formed terminal. The board terminal 240 extends between the mating end 242 and the terminating end 244. The board terminal 240 includes the intermediate body 246 between the mating end 242 and the terminating end 244. The mating end 242 extends vertically upward from the intermediate body 246, such as for connection to the control circuit board 158. For example, the mating end 242 includes a pin or tail for connection to the control circuit board 158. The terminating end 244 extends vertically upward from the intermediate body 246, such as for connection to the twist lock plug terminal 230. For example, the terminating end 244 includes a pad for welding or soldering to the twist lock plug terminal 230. In an exemplary embodiment, the intermediate body 246 includes a plurality of securing features 248, such as interference bumps, used to secure the board terminal 240 in the base 202.

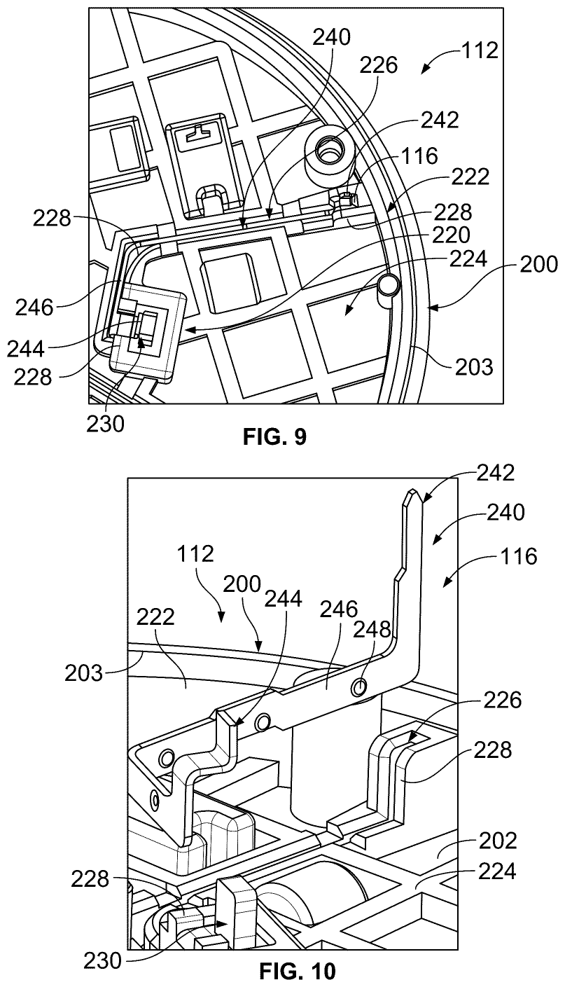

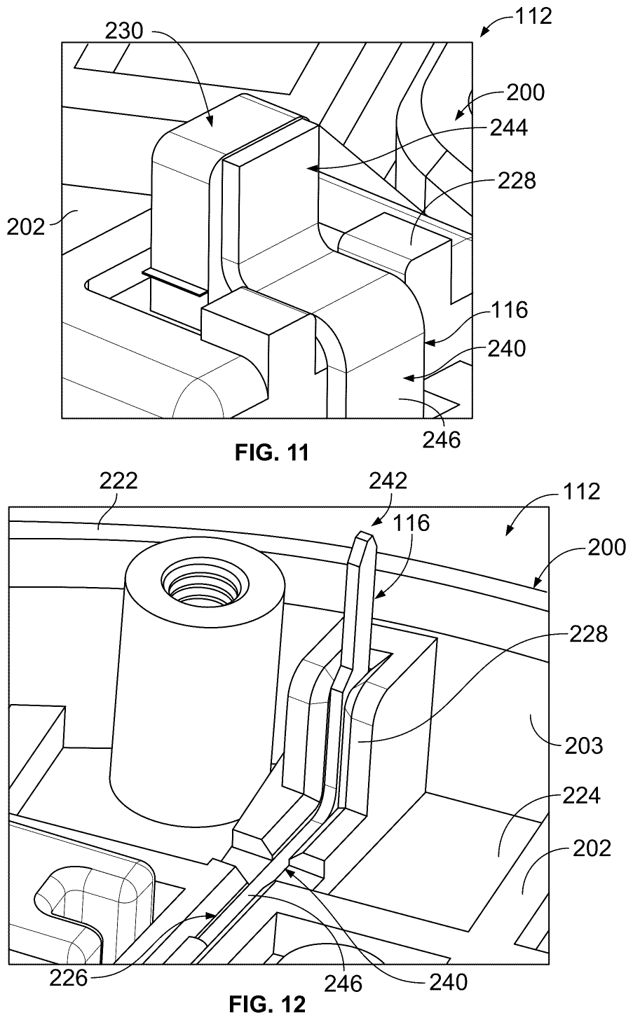

FIG. 9 is a top perspective view of a portion of the plug connector 112 shown in FIG. 7. FIG. 10 is a top perspective view of a portion of the plug connector 112 showing the board terminal 240 poised for loading into the base 202. FIG. 11 is a top perspective view of a portion of the plug connector 112 showing the terminating end 244 of the board terminal 240. FIG. 12 is a top perspective view of a portion of the plug connector 112 showing the mating end 242 of the board terminal 240.

The base 202 includes the inner hub 220, the outer rim 222, and the platform 224 between the inner hub 220 and the outer rim 222. The inner hub 220 is located in the central region of the base 202, such as aligned with the central axis. The outer rim 222 is located at the side wall 203 and is spaced radially outward of the inner hub 220. In an exemplary embodiment, the twist lock plug terminal 230 is arranged at the inner hub 220 and the board terminal 240 is configured to extend radially outward from the inner hub 220 toward the outer rim 222 for connection to the control circuit board 158 at a location remote from the inner hub 220. For example, the intermediate body 246 is received in the corresponding trough 226 and extends radially outward along the platform 224 between the inner hub 220 and the outer rim 222. The troughs 226 are formed in the platform 224 and provide a space that receives and supports the plug power contacts 116. The securing features 248 are used to secure the board terminal 240 in the trough 226, such as by an interference fit. The troughs 226 extend radially outward from the inner hub 220 to the outer rim 222. The locating walls 228 hold or locate the mating end 242 and/or the terminating end 244.

The terminating end 244 is configured to be electrically connected to the twist lock plug terminal 230, such as to the terminating end 234 of the twist lock plug terminal 230. For example, the terminating end 244 may be soldered or welded to the terminating end 234. The mating end 242 is configured to be electrically connected to the control circuit board 158 to electrically connect the twist lock plug terminal 230 to the control circuit board 158. In the illustrated embodiment, the mating end 242 includes a pin or a tail configured to be plugged into a plated via in the control circuit board 158. The tail may be soldered to the plated via. In other embodiments, the pin at the mating end 242 may be a compliant pin configured to be press fit in the plated via. The mating end 242 is located radially outward relative to the terminating end 244. For example, the terminating end 244 may be located at the inner hub 220 and the mating end 242 is located proximate to the outer rim 222. The mating end 242 is located proximate to a radially outer end of the plug connector housing 200, such as proximate to the side wall 203.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. A light control module for a light fixture comprising:
a plug connector configured to be mated with a receptacle connector mounted to the light fixture, the plug connector having a plug connector housing holding plug power contacts configured to electrically connect to receptacle power contacts of the receptacle connector for power control of the light fixture;
the plug connector housing having a base with a top and a bottom, the bottom configured to face the receptacle connector, the top configured to support a control circuit board, the base having power contact channels;
the plug power contacts received in the corresponding power contact channels, the plug power contacts including twist lock plug terminals and board terminals electrically connected to and extending from the twist lock plug terminals, the twist lock plug terminals having mating ends having rotate-to-mate interfaces configured to be connected to the receptacle power contacts in a rotation direction, the board terminals having mating ends configured to be electrically connected to the control circuit board to electrically connect the twist lock plug terminals to the control circuit board.

2. The light control module of claim 1, wherein the twist lock plug terminals and the board terminals are separate and discrete from each other.

3. The light control module of claim 1, wherein the board terminals extend radially outward from the twist lock plug terminals.

4. The light control module of claim 1, wherein the mating ends of the board terminals are located proximate to a radially outer end of the plug connector housing.

5. The light control module of claim 1, wherein the twist lock plug terminals include terminating ends exposed at the top of the base, the board terminals including terminating ends electrically connected to the terminating ends of the corresponding twist lock plug terminals.

6. The light control module of claim 1, wherein the base includes troughs at the top, the board terminals received in corresponding troughs.

7. The light control module of claim 6, wherein the board terminals include securing features configured to engage the base to hold the board terminals in the troughs.

8. The light control module of claim 1, wherein the base includes an inner hub and an outer rim spaced radially outward of the inner hub, the twist lock plug terminals located at the inner hub, the board terminals extending between the inner hub and the outer rim.

9. The light control module of claim 1, further comprising a sensor module coupled to the plug connector, the sensor module having a sensor module housing, a control circuit board held by the sensor module housing, and a sensor element coupled to the control circuit board, the sensor element held by the sensor module housing for sensing an environmental characteristic exterior of the sensor module, the control circuit board being mounted to the top of the base of the plug connector, wherein the mating ends of the board terminals are terminated to the control circuit board.

10. The light control module of claim 9, wherein the mating ends of the board terminals are terminated to the control circuit board proximate to an outer edge of the control circuit board.

11. The light control module of claim 1, wherein the board terminals are stamped and formed terminals.

12. The light control module of claim 1, wherein the board terminals are identical and extend from the respective twist lock plug terminals in different directions.

13. The light control module of claim 1, wherein the base includes locating walls for locating the board terminals relative to the base.

14. The light control module of claim 1, wherein the mating ends of the twist lock plug terminals are curved along arcuate paths.

15. The light control module of claim 1, wherein the board terminals are manufactured from a different material than the twist lock plug terminals.

16. The light control module of claim 1, wherein the plug connector housing is cylindrical having a central axis, the mating ends of the twist lock plug terminals arranged circumferentially around the central axis, the mating ends of the board terminals arranged circumferentially around the central axis spaced outward relative to the mating ends of the twist lock plug terminals.

17. A light control module for a light fixture comprising:
a plug connector configured to be mated with a receptacle connector mounted to the light fixture, the plug connector having a plug connector housing holding plug power contacts configured to electrically connect to receptacle power contacts of the receptacle connector for power control of the light fixture, the plug connector housing having a base with a top and a bottom, the bottom configured to face the receptacle connector, the base having power contact channels, the plug power contacts received in the corresponding power contact channels, the plug power contacts including twist lock plug terminals and board terminals electrically connected to and extending from the twist lock plug terminals, the twist lock plug terminals having mating ends having rotate-to-mate interfaces configured to be connected to the receptacle power contacts in a rotation direction, the board terminals having mating ends; and
a sensor module coupled to the plug connector, the sensor module having a sensor module housing, a control circuit board held by the sensor module housing, and a sensor element coupled to the control circuit board, the sensor element held by the sensor module housing for sensing an environmental characteristic exterior of the sensor module, the control circuit board being mounted to the top of the base of the plug connector, wherein the mating ends of the board terminals are terminated to the control circuit board.

18. The light control module of claim 17, wherein the mating ends of the board terminals are terminated to the control circuit board proximate to an outer edge of the control circuit board.

19. The light control module of claim 17, wherein the base includes an inner hub and an outer rim spaced radially outward of the inner hub, the twist lock plug terminals located at the inner hub, the board terminals extending between the inner hub and the outer rim.

20. A light control module for a light fixture comprising:
a receptacle connector configured to be mounted to the light fixture, the receptacle connector including a receptacle connector housing holding receptacle power contacts configured to be electrically connected to power wires of the light fixture, the receptacle connector housing including a mating interface at a top of the receptacle connector housing, the receptacle connector housing including power contact channels holding the corresponding receptacle power contacts, the receptacle power contacts including twist lock receptacle terminals having sockets at mating ends having rotate-to-mate interfaces;
a plug connector mated with a receptacle connector at the mating interface, the plug connector having a plug connector housing holding plug power contacts electrically connected to corresponding receptacle power contacts of the receptacle connector for power control of the light fixture, the plug connector housing having a base with a top and a bottom, the bottom facing the top of the receptacle connector, the base having power contact channels, the plug power contacts received in the corresponding power contact channels, the plug power contacts including twist lock plug terminals and board terminals electrically connected to and extending from the twist lock plug terminals, the twist lock plug terminals having mating ends having rotate-to-mate interfaces configured to be connected to the corresponding rotate-to-mate interfaces of the twist lock receptacle terminals in a rotation direction, the board terminals having mating ends; and
a sensor module coupled to the plug connector, the sensor module having a sensor module housing, a control circuit board held by the sensor module housing, and a sensor element coupled to the control circuit board, the sensor element held by the sensor module housing for sensing an environmental characteristic exterior of the sensor module, the control circuit board being mounted to the top of the base of the plug connector, wherein the mating ends of the board terminals are terminated to the control circuit board.
